(19) United States
(12) Patent Application Publication
(10) Pub. No.: US 2020/0132100 A1
(43) Pub. Date: Apr. 30, 2020

(54) CONNECTING UNIT FOR CONNECTING BACKREST WITH BED FRAME AND BED HAVING SAME

(71) Applicant: Inno-Sports Co., Ltd., Xiamen (CN)

(72) Inventor: Kwan Jun Choi, Xiamen (CN)

(21) Appl. No.: 16/601,255

(22) Filed: Oct. 14, 2019

(30) Foreign Application Priority Data
Oct. 29, 2018 (CN) 201821760793.7

(51) Int. Cl. F16B 12/56; A47C 19/00; F16B 12/30; A47C 19/12

(52) U.S. Cl. CPC F16B 12/56; A47C 19/12; F16B 12/30; A47C 19/005

(57) ABSTRACT

A bed includes a bed frame and a backrest coupled with the bed frame by a plurality of connecting units, each including first and second plate. The first plate is fixedly disposed at a first side of the bed frame and includes one or more slots elongated in the lateral direction of the bed frame. The second plate includes one or more rows of holes, and is fixedly coupled with the first plate by at least one fastener through at least one slot of the first plate and at least one hole of the second plate. Each connecting unit also includes one or more locking nuts fixedly disposed at the second plate, and one or more locking bolts. The one or more locking bolts pass through one or more holes or slots formed in the backrest and fixedly coupled with the one or more locking nuts of the second plate.

### CROSS-REFERENCE TO RELATED APPLICATIONS

The present application claims priority to Chinese Utility Model Application CN 201821760793.7 filed Oct. 29, 2018. The disclosure of the application is incorporated herein for all purposes by reference in its entirety.

### FIELD OF THE INVENTION

The present invention generally relates to beds, and more particularly, to connecting units for connecting backrests with bed frames and beds with backrests.

### BACKGROUND

Foldable beds are designed for convenient use and saving space. There are a variety of foldable beds in the market with different sizes and folding/unfolding mechanisms. However, existing backrests on the market are generally standardized with standard widths. In many cases, existing backrests do not match with existing foldable beds. As such, it is difficult, if not impossible, to install an existing backrest on an existing foldable bed to make the bed more comfortable.

Given the current state of the art, there remains a need for connecting units, bed frames and beds that address the abovementioned issues.

The information disclosed in this Background section is provided for an understanding of the general background of the invention and is not an acknowledgement or suggestion that this information forms part of the prior art already known to a person skilled in the art.

### SUMMARY OF THE INVENTION

The present invention provides connecting units for connecting backrests with bed frames, and beds with backrests.

In various exemplary embodiments, the present invention provides a connecting unit including a first plate and a second plate. The first plate is configured to be fixedly disposed at a first side of a bed frame, wherein the first plate includes one or more slots elongated in a lateral direction of the bed frame. The second plate includes one or more rows of holes. The first and second plates are configured to be fixedly coupled with each other by at least one fastener through at least one slot in the one or more slots of the first plate and at least one hole in the one or more rows of holes of the second plate. A connecting unit of the present invention also includes one or more locking nuts and one or more locking bolts. The one or more locking nuts are fixedly disposed at the second plate. The one or more locking bolts are configured to pass through one or more holes or slots formed at a backrest and fixedly coupled with the one or more locking nuts.

In some exemplary embodiments, the one or more slots of the first plate include an upper slot and at least one lower slot disposed below the upper slot.

In some exemplary embodiments, the one or more rows of holes of the second plate include an upper row of holes and a lower row of holes disposed below the upper row.

In some exemplary embodiments, each row in the one or more rows of holes includes a plurality of holes disposed spatially along the lateral direction of the bed frame.

In an exemplary embodiment, each row in the one or more rows of holes includes three holes disposed spatially along the lateral direction of the bed frame.

In some exemplary embodiments, the second plate is formed with a plurality of openings, wherein each locking nut in the one or more locking nuts is disposed in an opening in the plurality of openings and fixedly coupled with the second plate.

In an exemplary embodiment, the one or more locking nuts include an upper locking nut and a lower locking nut.

In some exemplary embodiments, the first plate is made of a metallic material.

In various exemplary embodiments, the present invention provides a bed including a bed frame having a first side and a backrest including a plurality of holes or slots. The bed frame and the backrest are connected with each other by a plurality of connecting units arranged spatially along a lateral direction of the bed frame. The plurality of connecting units fixedly couples the backrest with the first side of the bed frame. A connecting unit in the plurality of connecting units is any of the connecting units disclosed herein.

In some exemplary embodiments, each connecting unit in the plurality of connecting units includes a first plate and a second plate. The first plate is fixedly disposed at the first side of the bed frame and includes one or more slots elongated in the lateral direction of the bed frame. The second plate includes one or more rows of holes. The second plate is fixedly coupled with the first plate by at least one fastener through at least one slot in the one or more slots of the first plate and at least one hole in the one or more rows of holes of the second plate. Each connecting unit in the plurality of connecting units also includes one or more locking nuts, and one or more locking bolts. The one or more locking nuts are fixedly disposed at the second plate. The one or more locking bolts pass through one or more holes or slots in the plurality of holes or slots formed in the backrest and fixedly coupled with the one or more locking nuts of the second plate.

In some exemplary embodiments, the plurality of connecting units includes a first connecting unit and a second connecting unit disposed symmetrically with respect to a longitudinal central line of the bed frame.

In some exemplary embodiments, the one or more holes or slots in the plurality of holes or slots of the backrest include an elongated vertical slot.

In some exemplary embodiments, the bed frame is foldable.

In some exemplary embodiments, the first side is a head side of the bed frame.

The connecting units and bed frames of the present invention have other features and advantages that will be apparent from, or are set forth in more detail in, the accompanying drawings, which are incorporated herein, and the following Detailed Description, which together serve to explain certain principles of exemplary embodiments of the present invention.

### BRIEF DESCRIPTION OF THE DRAWINGS

The accompanying drawings, which are incorporated into and constitute a part of this specification, illustrate one or more exemplary embodiments of the present invention and, together with the Detailed Description, serve to explain the principles and implementations of exemplary embodiments of the invention.

FIG. 1 is a perspective view illustrating an exemplary bed in accordance with exemplary embodiments of the present invention.

FIG. 2 is a perspective view illustrating an exemplary connecting unit in accordance with exemplary embodiments of the present invention.

As will be apparent to those of skill in the art, the components illustrated in the figures described above are combinable in any useful number and combination. The figures are intended to be illustrative in nature and are not limiting.

### DETAILED DESCRIPTION

Reference will now be made in detail to implementations of exemplary embodiments of the present invention as illustrated in the accompanying drawings. The same reference indicators will be used throughout the drawings and the following detailed description to refer to the same or like parts. Those of ordinary skill in the art will understand that the following detailed description is illustrative only and is not intended to be in any way limiting. Other embodiments of the present invention will readily suggest themselves to such skilled persons having benefit of this disclosure.

In the interest of clarity, not all of the routine features of the implementations described herein are shown and described. It will be appreciated that, in the development of any such actual implementation, numerous implementation-specific decisions are made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

Many modifications and variations of the exemplary embodiments set forth in this disclosure can be made without departing from the spirit and scope of the embodiments, as will be apparent to those skilled in the art. The specific exemplary embodiments described herein are offered by way of example only, and the disclosure is to be limited only by the terms of the appended claims, along with the full scope of equivalents to which such claims are entitled.

Embodiments of the present invention are described in the context of connecting units configured to connect backrests with bed frames and beds having a backrest. The backrests and bed frames of the present invention can be of various sizes including but not limited to twin, full, queen and king sizes, and of various shapes including but not limited to rectangles and squares. They can be made of various materials including but not limited to metals (e.g., cast iron, steel, aluminum), plastics and woods.

In general, an exemplary connecting unit of the present invention includes a first plate and a second plate. An exemplary first plate is configured to be fixedly disposed on a bed frame and is formed with one or more slots elongated in a lateral direction of the bed frame. An exemplary second plate is formed with one or more rows of holes, and is fixedly coupled with the first plate through at least one slot in the one or more slots of the first plate and at least one hole in the one or more rows of holes of the second plate. An exemplary connecting unit also includes one or more locking nuts fixedly disposed at the second plate for fixedly coupling a backrest with the second plate. As such, the connecting unit of the present invention is flexible, and can be used to couple various sizes of bed frames with various sizes of backrests.

A bed of the present invention includes a bed frame, a backrest and a plurality of connecting units disclosed herein to couple the bed frame and backrest. The bed frame can be foldable or not foldable. In various exemplary embodiments, the plurality of connecting units is disposed at a first side of the bed frame and spaced apart along a lateral direction of the bed frame. The plurality of connecting units can include two, three, or more connecting units. In some exemplary embodiments, the first side is the head side of the bed frame.

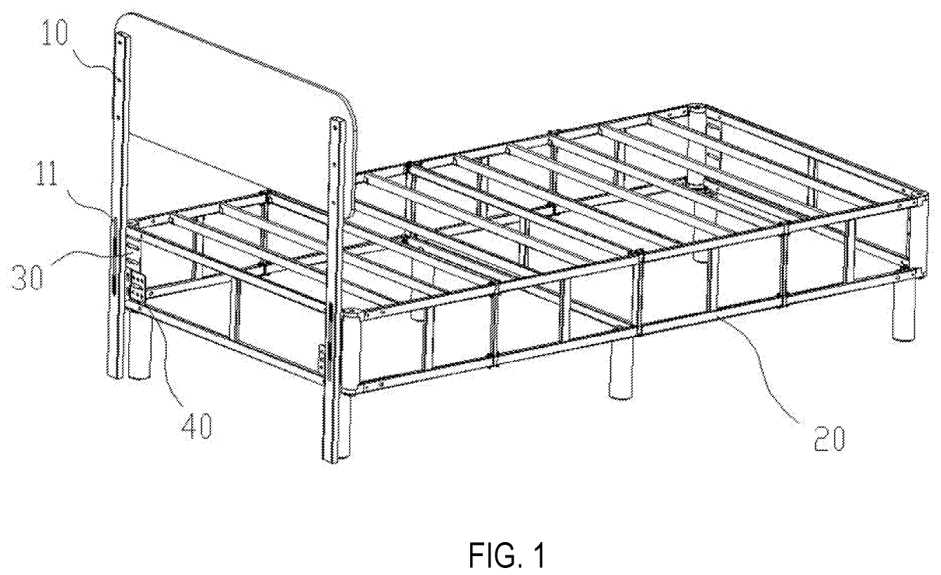

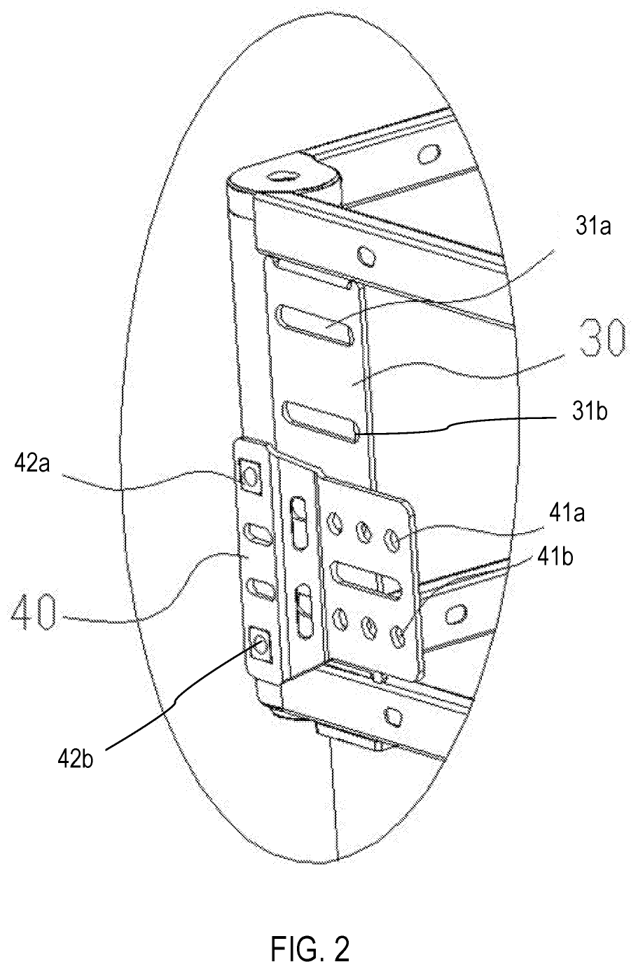

By way of example, FIGS. 1 and 2 illustrate an exemplary bed with backrest 10 coupled with bed frame 20 by a pair of connecting units. One connecting unit is disposed at a left side and the other connecting unit is disposed at a right side. In some exemplary embodiments, the two connecting units are disposed symmetrically with respect to a longitudinal central line of the bed frame.

In various exemplary embodiments, the connecting unit includes a first plate such as first plate 30 and a second plate such as second plate 40. In some exemplary embodiments, first plate 30 is formed with one or more slots elongated in the lateral direction of the bed frame. In some embodiments, first plate 30 is formed with two, three, four, five or more than five slots elongated in the lateral direction of the bed frame. By way of example, FIG. 2 illustrates first plate 30 formed with elongated upper slot 31a and elongated lower slot 31b below the upper slot. In some exemplary embodiments, the first plate is made of a metallic material such as iron.

In some exemplary embodiments, second plate 40 is formed with one or more rows of holes, each row including a plurality of holes disposed spatially along the lateral direction of the bed frame. It should be noted that the number of holes in one row can be the same or different from the number of holes in another row. By way of example, FIG. 2 illustrates two rows of holes, i.e., upper row 41a and lower row 41a below the upper row. Each row of holes includes three holes disposed spatially along the lateral direction of the bed frame. In some exemplary embodiments, the second plate is fixedly coupled with the first plate by at least one fastener through at least one slot in the one or more slots of the first plate and at least one hole in the one or more rows of holes of the second plate.

In various exemplary embodiments, the connecting unit of the present invention also includes one or more locking nuts fixedly disposed at the second plate. By way of example, FIG. 2 illustrates two locking nuts, i.e., upper locking nut 42a and lower locking nut 42b below the upper locking nut. In some exemplary embodiments, the second plate is formed with a plurality of openings, and each locking nut is disposed in an opening and fixedly coupled with the second plate.

In some exemplary embodiments, the connecting unit of the present invention further includes one or more locking bolts passing through one or more holes or slots such as slot 11 formed in the backrest and fixedly coupled with the one or more locking nuts of the second plate. In an exemplary embodiment, slot 11 is elongated in a vertical direction of the backrest.

The terminology used herein is for the purpose of describing particular implementations only and is not intended to be limiting of the claims. As used in the description of the implementations and the appended claims, the singular forms “a”, “an” and “the” are intended to include the plural forms as well, unless the context clearly indicates otherwise. It will be understood that the terms “lower” or “upper”, and etc. are used to describe features of the exemplary embodiments with reference to the positions of such features as displayed in the figures. It will be understood that, although the terms “first,” “second,” etc. may be used herein to describe various elements, these elements should not be limited by these terms. These terms are only used to distinguish one element from another. For example, a first plate could be termed a second plate, and, similarly, a second plate could be termed a first plate, without changing the meaning of the description, so long as all occurrences of the “first plate” are renamed consistently and all occurrences of the “second plate” are renamed consistently.

What is claimed is:

1. A connecting unit for connecting a backrest with a bed frame, the connecting unit comprising:
a first plate configured to be fixedly disposed at a first side of a bed frame, wherein the first plate comprises one or more slots elongated in a lateral direction of the bed frame;
a second plate comprising one or more rows of holes, wherein the first and second plates are configured to be fixedly coupled with each other by at least one fastener through at least one slot in the one or more slots of the first plate and at least one hole in the one or more rows of holes of the second plate;
one or more locking nuts fixedly disposed at the second plate; and
one or more locking bolts configured to pass through one or more holes or slots formed at a backrest and fixedly coupled with the one or more locking nuts.

2. The connecting unit of claim 1, wherein the one or more slots of the first plate comprise an upper slot and at least one lower slot disposed below the upper slot.

3. The connecting unit of claim 1, wherein the one or more rows of holes of the second plate comprises an upper row of holes and a lower row of holes disposed below the upper row.

4. The connecting unit of claim 1, wherein each row in the one or more rows of holes comprises a plurality of holes disposed spatially along the lateral direction of the bed frame.

5. The connecting unit of claim 1, wherein each row in the one or more rows of holes comprises three holes disposed spatially along the lateral direction of the bed frame.

6. The connecting unit of claim 1, wherein the second plate is formed with a plurality of openings, wherein each locking nut in the one or more locking nuts is disposed in an opening in the plurality of openings and fixedly coupled with the second plate.

7. The connecting unit of claim 1, wherein the one or more locking nuts comprising an upper locking nut and a lower locking nut.

8. The connecting unit of claim 1, wherein the first plate is made of a metallic material.

9. A bed comprising:
a bed frame having a first side;
a backrest comprising a plurality of holes or slots; and
a plurality of connecting units arranged spatially along a lateral direction of the bed frame for fixedly coupling the backrest with the first side of the bed frame, wherein each connecting unit in the plurality of connecting units comprises:
a first plate fixedly disposed at the first side of the bed frame and comprising one or more slots elongated in the lateral direction of the bed frame;
a second plate comprising one or more rows of holes and fixedly coupled with the first plate by at least one fastener through at least one slot in the one or more slots of the first plate and at least one hole in the one or more rows of holes of the second plate;
one or more locking nuts fixedly disposed at the second plate; and
one or more locking bolts passing through one or more holes or slots in the plurality of holes or slots formed in the backrest and fixedly coupled with the one or more locking nuts of the second plate.

10. The bed of claim 9, wherein the one or more slots of the first plate comprises an upper slot and at least one lower slot disposed below the upper slot.

11. The bed of claim 9, wherein the one or more rows of holes of the second plate comprises an upper row of holes and a lower row of holes disposed below the upper row.

12. The bed of claim 9, wherein each row in the one or more rows of holes comprises a plurality of holes disposed spatially along the lateral direction of the bed frame.

13. The bed of claim 9, wherein each row in the one or more rows of holes comprises three holes disposed spatially along the lateral direction of the bed frame.

14. The bed of claim 9, wherein the second plate is formed with a plurality of openings, wherein each locking nut in the one or more locking nuts is disposed in an opening in the plurality of openings and fixedly coupled with the second plate.

15. The bed of claim 9, wherein the one or more locking nuts comprising an upper locking nut and a lower locking nut.

16. The bed of claim 9, wherein the first plate is made of a metallic material.

17. The bed of claim 9, wherein the plurality of connecting units includes a first connecting unit and a second connecting unit disposed symmetrically with respect to a longitudinal central line of the bed frame.

18. The bed of claim 9, wherein the one or more holes or slots in the plurality of holes or slots of the backrest comprise an elongated vertical slot.

19. The bed of claim 9, wherein the bed frame is foldable.

20. The bed of claim 9, wherein the first side is a head side of the bed frame.
